(19) United States
(12) Patent Application Publication
(10) Pub. No.: US 2010/0047505 A1
(43) Pub. Date: Feb. 25, 2010

(54) OPTICAL STORAGE MEDIA AND METHOD FOR THE PRODUCTION THEREOF

(75) Inventors: Stephan Völkening, Köln (DE); Lars Krueger, Leverkusen (DE); Sascha Plug, Leverkusen (DE); Stefanie Eiden, Leverkusen (DE)

Correspondence Address: Baker Donelson Bearman, Caldwell & Berkowitz, PC, 555 Eleventh Street, NW, Sixth Floor, Washington, DC, 20004, US

(73) Assignee: BAYER INNOVATION GMBH, Düsseldorf (DE)

(21) Appl. No.: 12/518,468

(22) PCT Filed: Dec. 15, 2007
(86) PCT No.: PCT/EP2007/011039

§ 371 Date: Jun. 10, 2009

(30) Foreign Application Priority Data
Dec. 28, 2006 (DE) 10 2006 062 457.2

(51) Int. Cl. G11B 7/245; C08L 67/00

(52) U.S. Cl. 428/64.4; 525/418

(57) ABSTRACT

The present invention relates to optical storage layers and optical storage media having improved properties for the storage of information, data and images, containing an optical storage material produced from a mixture of at least one photoaddressable polymer and at least one additive, and the production and use thereof. In addition, the invention relates to optical security elements containing an optical storage material comprising at least one photoaddressable polymer and at least one additive.

The present invention relates to optical storage layers and optical storage media having improved properties for the storage of information, data and images, containing an optical storage material comprising at least one photoaddressable polymer and at least one additive, and the production and use thereof. The invention also relates to optical security elements.

Optical stores for recording, keeping and storage of information and data are nowadays ubiquitous, for example in the form of singly or multiply recordable compact disks or digital versatile disks (DVD) and laser cards.

In the development of novel optical stores, two main directions are generally followed, namely firstly increasing the storage density and storage capacity and secondly protecting the stored information from unauthorized access, copying and manipulation. While it has been possible to increase the storage capacity of optical media continuously in recent years, there are still only inadequate protection mechanisms against the copying, falsification, manipulation and/or unauthorized access to the information and data. The production of copies or reproduction is often possible by simple techniques. Even in the case of holographic security elements, copying is possible by a contact printing method (cf. for example P. Hariharan: Basics of Holography. University Press Cambridge (2002)).

In this context, so-called photoaddressable polymers have proved to be an interesting class of materials for use in optical storage media. These have very effective properties against copying, falsification, manipulation and/or unauthorized access to data and information (cf. for example S. Völkening, T. Hupe, H. Jüngermann; Sicherheitsanwendungen auf Basis intelligenter Speicherpolymere [Security applications based on intelligent storage polymers]; DACH Security 2005, Editor Patrick Horster; Syssec 2005; pages 408-414).

Photoaddressable polymers form a class of materials whose optical properties, such as absorption, emission, reflection, birefringence and scattering, can be induced by light to undergo reversible changes. Such polymers are characterized by the ability to form directed birefringence on exposure to polarized light (Polymers as Electrooptical and Photooptical Active Media, V. P. Shibaev (Editor), Springer Verlag, New York 1995; Natansohn et al., Chem. Mater. 1993, 403-411). It is furthermore known that localized birefringence whose preferred axis moves concomitantly on rotation of the direction of polarization can be written into layers, for example into films and sheets, of these polymers at any desired point using polarized light (K. Anderle, R. Birenheide, M. Eich, J. H. Wendorff, Makromol. Chem., Rapid Commun. 10, 477-483 (1989)). In this way, information can be introduced into the layer of photoaddressable polymer.

Serial write methods in which parts of the information are introduced in succession into the photoaddressable polymer layer are described, for example, in DE 100 07 410 A1 and DE 42 083 28 A1.

The inscribed birefringence patterns can be visualized in polarized light and read out. For this purpose, the polymer layer can, for example, be introduced between two crossed linear polarizers (polarizer/analyser), the photoaddressable layer being arranged so that the preferred direction within the polymer film is rotated through 45° relative to the polarizer. For reading out, the set-up comprising polarizer, polymer layer and analyser is irradiated. The light passes through the polarizer and is linearly polarized. The linearly polarized light strikes the layer of photoaddressable polymer. Regions which were not exposed lead to no change in the light beam. The light beam passes unhindered through these unexposed regions and strikes the analyser, which blocks the light. Exposed regions lead to a (partial) depolarization of the light beam passing through. A part of the (partly) depolarized light passes unhindered through the analyser. The exposed areas appear light against a dark background.

Layers which contain photoaddressable polymers as a film can therefore be used for storing information and data. Examples of such photoaddressable polymers are polymers having azobenzene-functionalized side chains, which are described, for example, in U.S. Pat. No. 5,173,381. On exposure to polarized light, the photoactive azobenzene groups in the azobenzene-functionalized polymer are aligned perpendicular to the polarization direction.

The photoaddressable polymers described in DE 196 31 864 A1 are copolymers which consist of a backbone and two types of side chains, namely photochromic and mesogenic side chains. On exposure to polarized light of certain frequencies, the photochromic side chains are stimulated to undergo a cis-trans-cis isomerization, which in turn leads to orientation of the side chains perpendicular to the polarization direction. This results in local birefringence. In this way, information can be written into the material. Owing to a molecular interaction between the photochromic and the mesogenic side chains, the mesogenic groups too are subject to a so-called cooperative, directed reorientation process. As a result of the reorientation of the mesogenic groups, amplification and stabilization of the reoriented molecules can be achieved. In addition, the information is also retained for a longer time in the polymer in this manner.

DE 197 202 88 A1 describes photoaddressable homopolymers in which the interaction between the side groups in the homopolymer is so strong that a cooperative directed reorientation process likewise results on exposure to polarized light.

In summary, it may therefore be stated that the molecular interactions between the side groups in the photoaddressable polymers are actually responsible for enabling the information to be written into the polymers by means of light. They are also substantially involved in ensuring that the information in the polymer is also permanently retained. Accordingly, it is essential that these interactions are not disturbed.

In the production of storage media, it has not been possible to date to produce films of photoaddressable polymers of any desired shape and size.

The application and the adhesion to a very wide range of substrates also continue to present problems. For applications in the area of optical data media and also in the area of security elements, however, good adhesion to the substrate is absolutely essential and the film must not flake off even on bending the substrate.

In addition, for optical applications, the films of photoaddressable polymers must not exhibit any tearing. However, the photoaddressable polymers most frequently described to date in the prior art are precisely those having a polymeric backbone of polymethacrylate, which generally have high brittleness.

The prior art, for example DE 197 20 288 A1, DE 196 318 64 A1, DE 44 349 66 A1 and DE 100 27 153 A1, states that films of photoaddressable polymers can be produced by a multiplicity of methods and can be applied to substrates. Nevertheless, it is precisely the formation of layers of any desired form and in particular for the coating of large areas with photoaddressable polymers that still presents difficulties. Thus, according to the example described in DE 197 20 288 A1, the photoaddressable polymers are only incompletely soluble in the solvents, and the wetting of the substrates was poor and/or the resulting layers were inhomogeneous and of nonuniform layer thickness. The spin coating method described, as a batch process, is unsuitable for producing layers of any desired form and in particular for the coating of large areas of photoaddressable polymers.

In the economical casting method, a film of defined layer thickness must be applied to a substrate. Parameters such as the viscosity and the surface tension of the casting solution have to be adjusted here. In methods for the production of an optical storage medium, difficulties arise because solutions described so far permit only the choice and structural variation of the photoaddressable polymers themselves and the variation of the concentration of photoaddressable polymer in solution or dispersion. In this way, it is possible to establish only a very small range of casting parameters for the production of the optical storage layer. Moreover, by variation of the concentration of photoaddressable polymer in the casting solution, the viscosity and the surface tension on the one hand and the amount of photoaddressable polymer in the resulting film on the other hand cannot be adjusted independently of one another.

Owing to the fact that the sensitive interactions of the side chains of the photoaddressable polymers are known to be responsible for the relevant properties of the photoaddressability, these interactions must not be disturbed and adversely affected. Additives which improve the mechanical or physical properties of the polymers in the production or in the resulting film may become lodged between the individual side chains of the photoaddressable polymer. In particular, such additives may remain in the resulting film. Those skilled in the art have therefore generally believed to date that addition of additives to the photoaddressable polymers or their solutions for improving the properties is not possible.

It is an object of the present invention to provide an improved optical storage material containing at least one photoaddressable polymer, in which the production in any desired shape and size and the application to a multiplicity of materials can be achieved without adversely affecting the properties in the optical storage of information. It is furthermore an object of the present invention to provide optical storage media containing an optical storage material having at least one photoaddressable polymer, which storage media have improved properties, and a method for their production and improved optical security elements.

The object is achieved, according to the invention, by an optical storage material according to Claim 1 and a method according to Claim 10 and an optical security element according to Claim 17. According to the invention, it is proposed to produce the optical storage material from a mixture containing at least one photoaddressable polymer and at least one additive.

This mixture may be, for example, a melt, a solution or a dispersion with at least one photoaddressable polymer, to which at least one additive is added. According to the invention, an optical storage layer can be produced from this mixture.

Below, an optical storage layer is understood as meaning a material into which information and data can be introduced by means of light and can be visualized again and/or read out, for example, with the aid of a light source. The information and data may be analogue or digital.

Contrary to the prejudices in the prior art, it was surprisingly found that, by the addition of one or more additives, not only is the production of an optical storage layer of any desired shape and size and on a very wide range of substrate materials permitted or improved but also the mechanical properties of the resulting optical polymer films can be substantially improved without adversely affecting the properties in the optical storage of information.

In addition, it was surprisingly found that, by addition of at least one additive to a photoaddressable polymer (PAP), or its solution or dispersion, the reorientation process of the side chains in the resulting optical storage layer can be accelerated and therefore even a positive effect on the write process can be achieved.

According to the invention, all compounds which can form directed birefringence on exposure to polarized light can be used as photoaddressable polymers for the optical storage layer (cf. Polymers as Electrooptical and Photooptical Active Media, V. P. Shibaev (Editor), Springer Verlag, New York 1995; Natansohn et al., Chem. Mater. 1993, 403-411). Examples of photoaddressable polymers are the abovementioned polymers having azobenzene-functionalized side chains. Further examples of photoaddressable polymers are described in EP 0622789 A1, DE 44 349 66 A1, DE 196 318 64 A1, DE19620588 A1, DE 10027153 A1, DE 10027152 A1, WO 196038410 A1, U.S. Pat. No. 5,496,670, U.S. Pat. No. 5,543,267, WO 9202930 A1 and WO 1992002930 A1. Preferably, an azobenzene-functionalized polymethacrylate is used as photoaddressable polymer.

According to the invention, additive is understood as meaning any material addition to the photoaddressable polymer or its solution or dispersion. This addition can preferably influence the mechanical, physical and/or chemical properties, such as, for example, the viscosity, surface tension or resilience of the photoaddressable polymer or of a solution or dispersion of the polymer.

According to the invention, for example, thickeners, plasticizers and/or surface-active substances can be used as additives. Substances which are soluble in the same solvent as the photoaddressable polymer are particularly preferably used as additives. Thus, better miscibility and distribution and a more homogeneous optical layer can be produced. Other known additives, for example from coating chemistry, can also be used according to the invention. These may also be, for example, antifoams or deaerators.

According to the invention, the concentration of additive in the mixture with the photoaddressable polymer is between 0.2 and 8% by weight, particularly preferably between 0.4 and 7% by weight. In the resulting dry film, the proportion of remaining additive is between 1 and 30% by weight.

The addition of one or more thickeners advantageously permits the adjustment of the viscosity of the polymer, of its dispersion and in particular of polymer solutions independently of the concentration of photoaddressable polymer. In this way, the film formation can be positively influenced and substantially more homogeneous films of the photoaddressable polymer can subsequently be achieved.

In a particular embodiment of the invention, polymers are used as thickeners. This makes it possible to produce highly viscous solutions by addition of, for example, a high molecular weight polymer, which solutions, however, have only a low concentration of additive. This is advantageous if a high viscosity is required by the process in order to produce films but at the same time the concentration of the additive remaining in the film is to be kept low.

Those polymers which have high transparency and as low a birefringence as possible themselves in the resulting film are preferably used as thickeners. Thus, they do not disturb or hinder the writing and the reading of the information and data.

Examples of thickener additives suitable according to the invention are polyesters, polyacrylates, for example PMMA, polyethers, e.g. polyethylene oxide or polypropylene oxide, polyetherpolyols, e.g. polyethylene glycol or polypropylene glycol, polyamides, polycarbonates, styrene/acrylonitrile copolymers, cellulose derivatives, e.g. ethylcellulose, and organically modified silicates, this list not being definitive.

According to the invention, it is also possible to use crosslinking multicomponent systems, such as 2-component polyurethane systems (PU) obtained from isocyanate and alcohol compounds. Polyether polyols are particularly preferably used as alcohol compounds. By means of such an advantageous combination of the photoaddressable polymer or its solution or dispersion with 2-component PU systems, it is possible, for example, to produce scratch-resistant coats in which optical information, data or images can also be written. Such photoaddressable coats can advantageously be applied to plastic parts, metallic parts and/or parts comprising composite materials, this list not being limiting.

According to the invention it is also possible to combine a plurality of different thickener additives with one another. This permits optimal adjustment of the polymer properties and properties of its solutions or dispersions during production and adjustment of the properties in the resulting film.

In another embodiment of the present invention, plasticizers are added to the photoaddressable polymer or the solution or dispersion of the at least one photoaddressable polymer. Suitable plasticizers according to the invention are, for example, trimellitates, aliphatic dicarboxylic acid esters, polyesters, phosphoric acid esters, fatty acid esters, hydroxycarboxylic acid esters, epoxides, sulphoxides, sulphones, phthalic acid esters and derivatives thereof, cyclohexanepolycarboxylic acids and derivatives thereof, polyvinyl alcohols, polyethers and polyetherpolyols, this list not being definitive. The addition of plasticizers has the advantage that the resulting film has substantially improved mechanical properties. Thus, this film is substantially more resilient and less brittle and exhibits less tearing. Moreover, the tensile strength of the optical storage layer is substantially improved even under mechanical load. The durability of the optical storage layer can thus be substantially prolonged.

According to the invention, crosslinking two-component systems, such as 2-component polyurethane systems (PU) obtained from isocyanate and alcohol compounds, can also be used as plasticizers. Polyetherpolyols can particularly preferably be used as alcohol compounds here.

According to the invention, it is also possible to combine a plurality of different plasticizer additives with one another. This permits optimum adjustment of the polymer properties and properties of its solutions or dispersions during the production and adjustment of the properties in the resulting film.

In a particularly preferred embodiment of the invention, polyetherpolyols and/or polyethers are used as an additive in the mixture with the photoaddressable polymer. These substances have the advantage that they simultaneously function as, and can be used as, thickeners and plasticizers. Thus, it is possible exactly to adjust the viscosity of the polymer mixture and to obtain very good film-forming properties. At the same time, the resulting film can advantageously be produced with improved resilience. Such optical storage layers produced according to the invention can moreover withstand substantially greater mechanical loads and exhibit an improved tensile strength.

According to the invention, polyethylene glycols (PEG) and polypropylene glycols (PPG) are particularly preferably used as the polyetherpolyol additive. These preferably have an average viscometric molecular weight of between 2000 and 100 000.

In another particularly preferred embodiment, polyethylene oxides (PEO) or polypropylene oxides (PPO) are used as the polyether additive. According to the invention, these preferably have an average viscometric molecular weight of between 100 000 and 500 000.

In a development of the invention, the storage layer itself can be used directly as the storage medium. The photoaddressable polymer can, for example, form a self-supporting film or a sheet.

The invention furthermore relates to an optical storage medium in which the described optical storage layers according to the invention can be applied to support materials, and to a method for the production thereof.

Preferably, the support material is in the form of a sheet. The supports and support materials are also referred to below as substrate. According to the invention, the shape, size or thickness of the substrate is advantageously not limited. The photoaddressable polymers can be applied to a substrate layer, in particular to a support sheet, by all known techniques, for example from a solution which, according to the invention, contains at least one additive. Said techniques may be, for example, spin coating, spraying, knife coating, dip coating or casting. The solution exhibits substantially improved wetting of the substrates and improved film formation on the substrate.

According to the invention, gap coating, knife over roll coating, knife over blanket coating, floating knife coating, air knife coating, immersion (dip) coating, curtain coating, rotary screen coating, reverse roll coating, gravure coating, metering rod (Meyer bar) coating and slot die (slot, extrusion) coating are preferably used as a process for applying the film to the support.

The substrate on which the optical storage layer can be applied imparts mechanical stability to the optical data store. Alternatively or additionally, the substrate can perform further functions for further system integration. For example, the substrate can act as an adhesive film. According to the invention, acrylonitrile/butadiene/styrene (ABS), polycarbonate (PC), PC/ABS blends, polyethylene terephthalate (PET), polyethylene naphthalate (PEN), polyvinyl chloride (PVC), polymethyl methacrylate (PMMA), polyester, polyethylene (PE), polypropylene (PP), cellulose and its derivatives, polyamide (PA), cycloolefin polymers and copolymers (COP), polyphenylene sulphide (PPS) or polyimide (PI), but also glass and metallic support layers, can be used as suitable substrate material, this list not being definitive.

In a further embodiment of the present invention, the substrate or the support sheet can additionally be provided with a reflective layer before coating with the photoaddressable polymer. This reflective layer can improve certain methods for reading out the information stored in the optical film or can permit alternative read-out methods. In such an embodiment, the reflective layer may be a metal layer. For example, metals such as aluminium, titanium, gold, chromium, bismuth and silver or alloys can be used for this reflective layer. According to the invention, aluminium, chromium and silver are preferred.

The production of the metal layer can be effected by known methods, such as, for example, galvanizing, vapour deposition, wet chemical application and sputtering. Commercially available thermoplastic sheets which are already metallized are likewise suitable according to the invention as a support sheet.

In another embodiment, the reflective layer may be in the form of a multilayer structure. Here, the required or desired degree of reflection is achieved by targeted multiple reflections within the layer structure.

The films according to the invention, comprising photoaddressable polymer and at least one additive, advantageously have good adhesion both to polymer substrates and to the metallic or metallized surface layers. The mechanical load capacity of the optical storage medium is thus positively influenced and its durability prolonged.

In a further preferred embodiment of the present invention, the surface of the substrate can undergo a plasma or corona treatment before application of the film with the photoaddressable polymer. By means of this measure, the adhesion of the optical film can be further improved.

In another development of the present invention, the film comprising photoaddressable polymer and additive can be provided with one or more outer layers. As a result, the optical storage layer can be protected, for example, from scratching and/or harmful environmental influences, such as sunlight, oxygen, moisture and/or chemicals. This outer layer may be in the form of, for example, a coat or sheet or another transparent layer as free as possible of birefringence.

The optical storage media produced according to the invention can be used for the recording of analogue and digital data and images and information. In this connection, they have substantially improved properties, for example when inscribing the information. They also have improved mechanical properties, improved adhesion and homogeneity of the optical film on the substrate. The optical storage layers can withstand higher mechanical loads and also have longer durability. By the use according to the invention of additives which positively influence the film formation in the production process and/or the properties of the resulting optical storage layer, the form and properties of the optical storage medium can be made substantially more variable and can be adapted to the respective requirements in use.

Such optical storage media according to the invention can be particularly advantageously used as storage media for sensitive data and information worthy of protection, such as, for example, in passes, ID cards, tickets and labels or in the area of product protection.

The present invention furthermore relates to optical security elements containing an optical storage layer according to the invention, produced from a mixture of at least one photoaddressable polymer with at least one additive. According to the invention, this includes all embodiments and combinations of developments of the optical storage layer.

The use of a layer according to the invention of a photoaddressable polymer as an optical storage element is particularly advantageous because it is possible to write into this layer birefringence patterns which are not detectable with the naked eye. Once such an optical security feature has therefore been introduced, for example, into the packaging of a product to be protected, it is not possible with the naked eye to detect that it is a security feature. This advantageously makes it more difficult for potential product forgers to detect that a product has been provided with a security feature at all. The reading out of the optical security element and hence also the authenticity testing can be effected with the aid of a polarization optical system. Only with the use of a polarization optical system is the information in the polymer layer visible and can be read out. Forgery of the optical security element according to the invention is therefore not possible without a knowledge of the technology used and without a knowledge of the optical storage material according to the invention. Simple imitation or copying by printing techniques is ruled out. The optical storage layer according to the invention moreover has improved mechanical, physical and/or chemical properties.

All known writing methods can be used for introducing the information into the optical storage layer of the security element. These are, for example, photographic exposure, forward writing and reverse writing. The writing method used may depend, inter alia, on the application. In principle, the use of lasers or monochromatic light sources is not required. The light source must merely emit radiation having a wavelength at which the photoaddressable polymer is stimulated to induce orientation of the chromophores. In the case of azobenzene-functionalized side chain polymers, the light source must emit radiation having a wavelength which leads to a trans-cis-trans isomerization (R. Hagen, T. Bieringer: Photoaddressable Polymers for Optical Data Storage. In: Advanced Materials, WILEY-VCH Verlag GmbH (2001), No. 13/23, pages 1805-1810). In the simplest case it may be an incandescent bulb having a wide spectral range. Preferably, a projector, for example a commercially available beamer, can be used for projecting any number of images into the optical storage layer of the security element, before which projector a polarizer is arranged for producing linearly polarized light. As an alternative to images, it is also possible to write machine-readable information into the optical storage layer. This may be, for example, bar codes, matrix codes and/or an OCR (optical character recognition) text.

In a further development of the invention, masks can also be written into the optical storage layer of the security element by exposure to light.

In another embodiment according to the invention, a focused, polarized light beam can be scanned over the surface of the optical storage layer and the light source can be switched on at the points at which exposure is to be effected. Alternatively, the light can reach the optical storage layer via a shutter.

In a development of the invention, the optical security element is designed in such a way that the optical storage layer present therein is transparent and optionally the substrate and/or the material bonded thereto are transparent. Reading out can then be effected in a known manner. This can be carried out, for example, by introducing the optical storage layer between two crossed linear polarizers, the cross polarizers preferably being rotated through 45° relative to the preferred direction in the polymer layer. In this case, the polarization optical system may consist of a light source, which in the simplest case may be an incandescent bulb, and the polarizers between which the optical security element is introduced. The exposed parts appear light against a dark background. Alternatively, the linear polarizers can also be arranged parallel to one another. In this case, the exposed parts appear dark against a light background. Analogously, it is also possible to use two circular polarizers, by means of which a positive and negative representation can likewise be produced.

In a preferred development of the present invention, a reflective layer can be provided in the optical security element, below the optical storage layer. In this case, an authenticity test can advantageously be effected by installing a polarizer (linear or circular) immediately before the security element and exposing the security element to light through the polarizer. The light transmitted by the polymer layer and reflected by the reflective layer can in turn be viewed through the polarizer. With the use of a linear polarizer, the exposed parts appear dark against light background at an angle of 45° to the preferred direction of the polymer layer. Advantageously, simple authenticity testing of the optical security element according to the invention is thus provided by using only one polarizer and a light source. A further advantage of this embodiment is that the optical security element can also be applied to opaque objects. In addition, especially in conjunction with the material to be protected, the optical security element need no longer be positioned between two polarizers for easy reading out and/or for authenticity testing. This considerably extends the range of use of the optical security elements according to the invention for increasing forgery protection. Surprisingly, it was found that the reflectivity of the reflective layer need not be very high in order to be able to read out the optical security element. A metal layer is therefore not absolutely essential. Once the optical storage layer has been applied, for example, to a transparent support sheet, the reflectivity of the back of the support sheet (back-reflection) may be sufficient. The lower the degree of reflection, the more weakly the image introduced by exposure appears during read-out. However, the degree of back-reflection can in principle be below 1%.

In a preferred development of the invention, various images having different polarization directions can be introduced into the optical storage layer by exposure. Here, the pixels of the individual images can preferably be set so that they do not overlap in the polymer layer. Surprisingly, it was found that in this way several pieces of information can be written “one on top of the other” into the optical storage layer, which can be read out in succession without having a disturbing effect on the other information during read out of one piece of information. Advantageously, several pieces of information which, however, are not simultaneously visible can therefore be present side by side in the optical security element according to the invention, in a region within the photoaddressable polymer layer. This makes it possible additionally to increase the forgery-proof character of the optical security element according to the invention.

In a particularly preferred development of the invention, two images can be introduced into the optical storage layer by exposure to linear light, the polarization directions during the exposures of the two images being rotated through 45° relative to one another. In this case, no image within the optical storage layer is detectable to the naked eye. If the optical security element with the two images is illuminated with a linear polarizer and the reflected light is observed through the same polarizer, it is possible to detect one of the images if the polarizer is arranged at 45° relative to the preferred axis which has resulted on exposure of this image in the polymer. The preferred axis in the case of the respective other image may be parallel or perpendicular to the polarization direction of the polarizer. As a result, the respective other image may remain invisible. On rotation of the polarizer through 45°, the previously visible image disappears and the other image appears. In this way, the two images can advantageously be visualized in succession. The images do not mutually interfere during reading out of the respective other image.

In an advantageous development of the optical security element, one or more images introduced into the optical layer by exposure can be deliberately deleted or overwritten while one or more other images are retained. Selective deletion can be achieved according to the invention if only the pixels which form the one image are exposed again while the pixels which form another image are, however, not exposed again. According to the invention, a new image can be introduced by exposure for overwriting; for deletion, the pixels can be exposed to circularly polarized light (cf. also Example 5). This advantageous effect can be employed, for example, when using the optical security element according to the invention in tickets. One of the images may contain, for example, information about the validity of the ticket. On validation of the ticket, for example, this information can be deleted or can be overwritten with other information.

In a further development of the present invention, an optical protective layer can be applied to the polymer layer after the inscribing of the optical storage layer.

According to the invention, an optical protective layer is understood as meaning a layer which absorbs or reflects, but does not allow through, light having a wavelength which can lead to deletion and/or overwriting. This optical protective layer may additionally perform other protective functions of an outer layer. The optical security element according to the invention can advantageously then still be read out with light of another wavelength but not subsequently changed or even deleted in an unauthorized manner. Since the exposure of photoaddressable polymers is a reversible process, it may be expedient to protect information which has been written in from being deleted and/or overwritten. In this way, a further improvement of the forgery protection can be achieved.

According to the invention, the optical storage layer can be inscribed before or after coating with the optical protective layer. For reasons relating to production technology, it may be disadvantageous to provide the optical storage layer with an optical protective layer after inscribing. Surprisingly, it was found that the optical storage layer can be provided with a protective film prior to exposure. In this case, the writing can also be effected from the back, i.e. the side facing away from the protective layer. The optical storage layer can then be applied with the exposed side on a material to be protected.

In a further development of the invention, the optical security element may have a structure with the sequence comprising an optical protective layer, an optical storage layer and a reflective metal layer. Advantageously, the inscribing can be effected by exposure to light from the side of the metal layer since metals can be applied in very thin layers which have sufficient transmissivity for the exposure (cf. also Example 6).

In another preferred embodiment, the optical storage layer can preferably have a thickness which is chosen so that the phase difference between wave trains polarized perpendicular and parallel to the preferred direction of the polymer layer is λ/2 or an odd multiple thereof (λ=wavelength of the read light). A maximum contrast between light and dark regions can therefore advantageously be produced during read out.

According to the equation ΔL=(n_{P}−n_{S})d (where ΔL=difference between the optical path lengths; n_{P}=refractive index at 25° C. parallel to the preferred direction; n_{S}=refractive index at 25° C. perpendicular to the preferred direction; d=layer thickness of the polymer film), the phase difference can be controlled by the difference between refractive indices n_{P}-n_{S} and the layer thickness. The difference between refractive indices is dependent on the exposure parameters (duration of exposure and intensity). There is a maximum difference between refractive indices for each optical storage material, which difference is reached when all chromophores in the exposed layer are oriented perpendicular to the inscribed polarization direction (saturation behaviour).

In one development, the optical security element according to the invention can be connected to materials in such a way that the optical storage layer is applied directly to the material. This can be effected, for example, by printing, casting or other known methods. Alternatively, the security element can be produced separately from the material and subsequently connected to the material. For example, the security element may be in the form of a sheet or composite sheet having a reflective layer.

Combinations of different developments and advantageous embodiments of the optical storage medium with variants of the optical security element are also within the scope of the invention.

The invention is explained in more detail below in relation to the figures, without being limited thereto. In the figures,

FIG. 1 shows the structural formula of a photoaddressable polymer according to the invention,

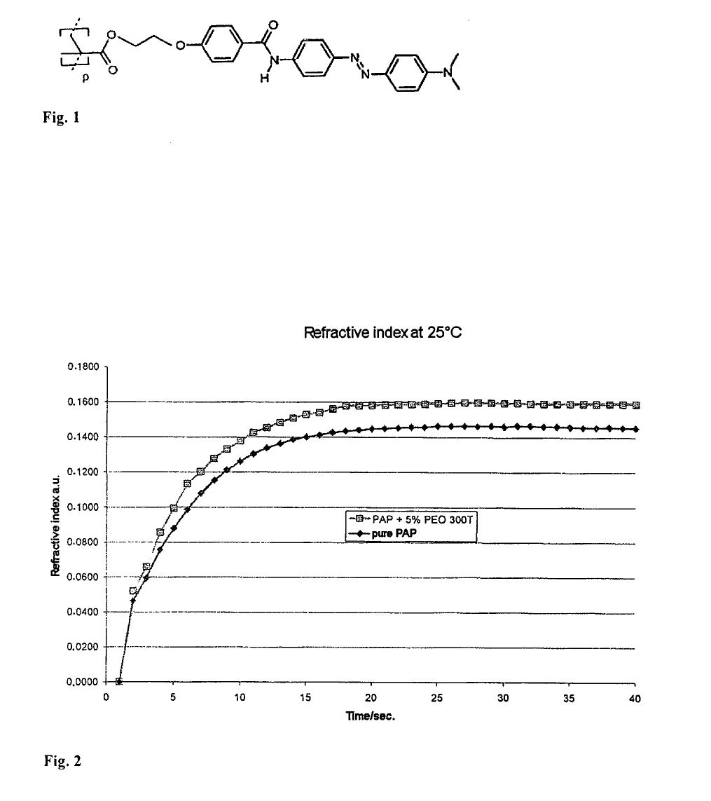

FIG. 2 shows exposure curves of different optical storage films and

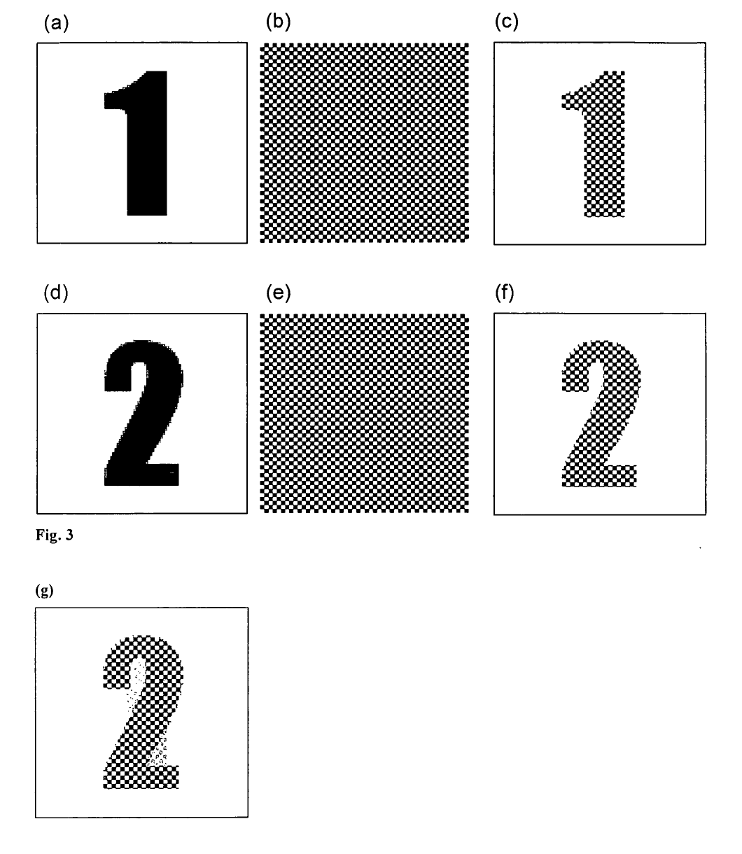

FIG. 3 a-g each show an example of the introduction of different images by exposure into an optical storage layer.

FIG. 1 shows the structural formula of a photoaddressable polymer, namely of an azobenzene-functionalized polymethacrylate, the preparation of which is described in WO 98/51721.

FIG. 2 shows the exposure curves of various optical storage films. The optical storage films were exposed to green laser light (cf. also Example 3) and birefringence was thus induced in the film. This birefringence was read out with time resolution by means of a red laser. Two curves are shown. Here, the lower curve shows the change in the refractive index at 25° C. of a layer of a pure photoaddressable polymer (PAP). In the upper curve, 5% of polyethylene oxide having an average viscometric molecular weight of 300 000 is present in the PAP layer. With a proportion of 5% of PEO (average viscometric molecular weight 300 000), the optical storage layer according to the invention achieves a higher refractive index than the pure PAP layer. This is a clear improvement of the optical properties compared with the pure PAP layer without an additive.

FIG. 3 a to 3 g show an example of the introduction of two different images into an optical storage layer by exposure. The images to be written show the numbers “1” and “2” (cf. FIGS. 3 (a) and (d)). The image with the “1” is processed with a mask (FIG. 3 (b)) so that it is composed of only half of the elements (FIG. 3 (c)). The image with the “2” is processed analogously with a mask (FIG. 3 (e)), this mask omitting exactly those elements in the image with the “2” which are set in the image with the “1”. This becomes clear when the two images are placed one on top of the other. This is shown in FIG. 3 g, the image with the “1” being coloured grey for clarity.

The invention is explained in more detail in relation to the following examples, without being limited thereto.

### EXAMPLES

For all examples below, the azobenzene-functionalized polymethacrylate shown in FIG. 1 was used as photoaddressable polymer (PAP), the preparation of which is described in WO 9851721.

### Example 1

### Preparation of a PAP Additive Solution

20 g of PAP are introduced together with 1 g of additive into a container, and 79 g of cyclopentanone are added. The mixture is heated to 70-80° C. with stirring and is stirred for a few minutes (with refluxing). The result is an orange to deep red solution, a 20% strength by weight PAP solution with a proportion of 1% by weight of additive.

The PAP solutions shown in Table 1 (a, b) are prepared analogously. Table 1 (a, b) also summarizes the viscosities of 10 and 20% by weight PAP solutions with varying additives and amounts of additive.

TABLE 1
Viscosities of PAP solutions with different proportions of different
additives (measured by means of rotation viscometry in the
CVO 120 HR viscometer from Bohlin Instruments in the CP 4/40
measuring system).
Table 1 (a)

| | % by weight of PEG/PEO in solution | | | |
|---|---|---|---|---|
| | 0 | 1 | 2.1 | 3.4 |
| | Viscosity [mPas] | | | |
| PAP 20% by weight & PEG 35T | 12 | 12.9 | 25.1 | 39.3 |
| PAP 20% by weight & PEO 100T | 12 | 17.6 | 39 | 71.3 |
| PAP 20% by weight & PEO 200T | 12 | 32.2 | 62.9 | 157 |
| PAP 20% by weight & PEO 300T | 12 | 31.9 | 56.3 | 156 |

Table 1 (b)

| | % by weight of PEG/PEO in solution | | | |
|---|---|---|---|---|
| | 0 | 0.5 | 1.05 | 1.7 |
| | Viscosity [mPas] | | | |
| PAP 10% by weight & PEG 35T | 3.2 | — | — | 5.6 |
| PAP 10% by weight & PEO 100T | 3.2 | — | — | 10.8 |
| PAP 10% by weight & PEO 200T | 3.2 | — | — | 12.7 |
| PAP 10% by weight & PEO 300T | 3.2 | — | — | 11.4 |

Viscosities at a shear rate of 11.3 1/s

In the parameter range shown, the solutions exhibit Newtonian behaviour. It is clear that the viscosity of the solution can be varied over a wide range by the choice of the additive and/or of the additive concentration (up to about 157 mPa·s). By variation of only the concentration of PAP, on the other hand, only the parameter range from about 1.2 mPa·s (pure cyclopentanone) to 12 mPa·s (20% by weight PAP solution in cyclopentanone) is achievable. A solution of PAP in cyclopentanone having a proportion by weight of more than 20% is not stable, and the photoaddressable polymer (PAP) is precipitated as a solid in the course of time.

### Example 2

### Application of a PAP Solution to a Reflective Glass Support by Means of Spin Coating

For carrying out the optical measurements, the solutions are applied to a reflective glass substrate in order to produce optical storage films. For this purpose, round laser mirrors from Topas (type BK7 Al+SiO2) having a diameter of 20 mm and a thickness of 5 mm are used.

The coating is carried out with the aid of spin coating. For this purpose, a “Karl Süss CT 60” spin coater is used. A laser mirror is fixed to the turntable of the device, covered with a solution from Example 1 and caused to rotate for a few seconds. Depending on the rotation programme of the device (acceleration, speed of rotation and rotation time), transparent, amorphous coatings of high optical quality with a coverage of 0.97 to 1.03 g/m² are obtained. By storing the coated glass support for 24 h at room temperature in a vacuum cabinet, residues of the solvent are removed from the coatings.

### Example 3

### Measurement of the Optical Properties

The samples from Example 2 are exposed to linearly polarized, green (523 nm) laser light. This induces birefringence in the material, which birefringence is read out with the aid of a red, linearly polarized diode laser (650 nm) at an angle of 45° to the polarization direction of the green laser. An appropriate apparatus is described in: R. Hagen et al., Photoaddressable Polymers for Optical Data Storage, Advanced Materials, 2001, 13, No. 23, pages 1805-1810.

The measurements result in exposure curves in which the build-up of the birefringence Δn in the material is plotted as a function of time (cf. also FIG. 2).

### Example 4

### Optical Security Element, Production and Authenticity Testing

For better handling properties, the optical storage material is applied from a 20% strength solution in cyclopentanone to a commercially available PET film having a thickness of 100 μm by knife coating. The layer thickness is 1.6 to 2 μm.

In the case of optical security elements which are read out in reflection, an aluminium layer having an optical density of about 0.8 is introduced between the PET film and the layer with the photoaddressable polymer. In the case of security features this authenticity is tested in transmission, the metal layer is dispensed with.

With the aid of a projector (Sharp PG-MB65X XGA, DLP technology, 3000 Ansi Lumen) and a downstream collecting lens (focal distance 100 mm), a black/white image is projected onto an optical storage layer having an aluminium layer arranged underneath. A linear polarizer is present between collecting lens and optical storage layer. The image on the layer of photoaddressable polymer has a size of about 2 cm in diameter. The image which the projector produces is image-filling, i.e. the image field of 1024×768 pixels of the projector is used to the maximum, and has a brightness of about 25%. Exposure is effected for 1 minute. The result is an optical security element which is not detectable with the naked eye. If a linear polarizer is placed on the security element and rotated through 45° relative to the preferred optical axis in the polymer, the image introduced by exposure can be detected as dark against a light background in the reflected beam through the polarizer.

### Example 5

### Optical Security Element Having Two Images, Production and Authenticity Testing

It is intended to introduce two images “one on top of the other” by exposure into the optical storage layer with an aluminium layer arranged underneath. The images to be written show the numbers “1” and “2” (cf. FIGS. 3 (a) and (d)). The image with the “1” is processed using a mask (FIG. 3 (b)) so that it is composed of only half the elements (FIG. 3 (c)). The image with the “2” is processed analogously using a mask (FIG. 3 (e)), this mask omitting exactly those elements in the image with the “2” which are set in the image with the “1”. This is clear when the two images are placed one on top of the other. This is shown in FIG. 3 g, the image with the “1” being coloured grey for the sake of clarity.

The two images are introduced in succession into the optical storage layer by exposure to linearly polarized light analogously to Example 1. The polarization direction in the case of the second image is rotated through 45° relative to the polarization direction in the case of the first image. Because in each case different pixels are used for the exposure of the two images, the first image is not overwritten during the exposure of the second image; the two images are present side by side in the optical storage layer. This results in birefringence patterns which are written into the optical security element and which are not detectable with the naked eye. For reading out, a linear polarizer is placed on the security element. The two images can be read out if the linear polarizer is rotated through 45° relative to the preferred axis of the respective image. The respective other image remains invisible.

The image with the “2” is subsequently selectively deleted. For this purpose a mask of the type from FIG. 3 e is introduced into the security element by exposure with the same parameters as was the case beforehand for introducing the “2” by exposure. The polarizer used here is a circular polarizer. The image with the “2” is thus deleted while the image with the “1” is retained.

### Example 6

### Security Element Having an Optical Protective Layer

An optical storage layer is applied to a polyamide-12 substrate having a thickness of 200 μm. A polyurethane coat in which a dye is incorporated is applied as an optical protective layer to the film of the optical storage layer. The polyurethane coat is a mixture of Desmophen 651 MPA (25.6% by weight) and Desmophen 670 BA (6.9% by weight) as the alcohol component, and Desmodur N3390 BA (20.8% by weight) as the isocyanate component, with diacetone alcohol (34.5% by weight) and methyl ethyl ketone (12.2% by weight) as solvents. A few mg of zinc octanoate were added as a catalyst. The coat is applied directly to the optical storage layer.

The dye used is Orasol Red BL from Ciba. This dye is incorporated into the alcohol component before the isocyanate component is added for the formation of the polyurethane coat. The concentration of dye in the coat is about 5% by weight.

The dye blocks the wavelengths which lead to the orientation of the azobenzene chromophores in the photoaddressable polymer from FIG. 1 which is used but allows through red light for reading out. The coat thickness is about 2 μm.
The security element is exposed to light from the side facing away from the coat, analogously to Example 4. As expected, exposure from the side facing the coat was not successful. The image can be read out from both sides with the aid of a polarization film which is rotated through 45° relative to the preferred direction in the polymer.
It is also possible to delete the image from the side facing away from the coat with the aid of uniform exposure to circularly polarized light. As expected, deletion from the side facing the coat is not possible.

All experiments can be carried out using a film in which a reflective layer is arranged underneath the optical storage layer. Here, the exposure time is set about 10 times higher since the reflective layer has to be penetrated during writing in of the images.

In summary, according to the invention, an optical storage layer and an optical storage medium having improved properties and a method for the production thereof are provided. In addition, an optical security element which has improved properties, is forgery-proof and can be tested for authenticity by simple means is provided.

1. An optical storage layer, produced from a mixture of at least one photoaddressable polymer and at least one additive.

2. An optical storage layer according to claim 1, wherein the additive is a thickener and/or a plasticizer and/or a surface-active substance.

3. An optical storage layer according to claim 1, wherein the additive is a polymer.

4. An optical storage layer according to claim 1, wherein the additive is a polyether or a polyetherpolyol.

5. An optical storage layer according to claim 4, wherein the polyetherpolyol is a polyethylene glycol or a polypropylene glycol.

6. An optical storage layer according to claim 5, wherein the polyetherpolyol has an average viscometric molecular weight of between 2,000 and 100,000.

7. An optical storage layer according to claim 4, wherein the polyether is a polyethylene oxide or a polypropylene oxide.

8. An optical storage layer according to claim 4, wherein the polyether has an average viscometric molecular weight of 100,000 to 500,000.

9. An optical storage layer according to claim 1, wherein the total amount of additive is between 1 and 30% by weight, based on the total weight of said later.

10. An optical storage medium, comprising an optical storage layer of claim 1 is applied to a substrate.

11. An optical storage medium according to claim 10, wherein the optical storage layer has a thickness from 200 nm to 2 μm.

12. An optical storage medium according to claim 10, wherein the substrate is reflective and/or is provided with an additional reflective layer.

13. An optical storage medium according to claim 10, wherein the optical storage layer is provided with a transparent outer layer.

14. A method for the production of an optical storage medium according to claim 10, comprising applying an optical storage layer to a substrate.

15. A method for the recording of analogue and/or digital data and/or information comprising using an optical storage layer of claim 1.

16. A method for the recording and/or storage of analogue and/or digital data and/or information comprising using an optical storage medium of claim 10.

17. A method according to claim 16 wherein the optical storage medium comprises a pass, an ID card, a ticket and/or a label.

18. An optical security element comprising an optical storage layer produced from a mixture of at least one photoaddressable polymer and at least one additive.

19. An optical security element according to claim 18, wherein the optical storage layer is applied to a substrate.

20. An optical security element according to claim 19, wherein the substrate is reflective and/or a reflective layer is arranged underneath the optical storage layer.

21. An optical security element according to claim 18, wherein a plurality of data or images having different polarization directions are written one on top of the other into the optical storage layer by means of polarized light.

22. An optical security element according to claim 21, wherein the plurality of data or images written in are produced so as not to overlap.

23. An optical security element according to claim 21, wherein one or more data and/or images can be deliberately deleted and/or overwritten.

24. An optical security element according to claim 18, wherein the optical storage layer is provided with an optical protective layer.

25. An optical security element according to claim 18, wherein the thickness of the optical storage layer is chosen so that a phase difference between wave trains polarized perpendicular and parallel to a preferred direction in the optical layer is λ/2 and/or an odd multiple thereof, wherein λ is the wavelength of a read light.

26. A method of forgery protection for passes, ID cards, tickets and/or labels comprising using an optical security element according to claim 18.
